(19) United States
(12) Patent Application Publication
(10) Pub. No.: US 2013/0045265 A1
(43) Pub. Date: Feb. 21, 2013

(54) ANTIMICROBIAL STRAP

(71) Applicant: Barry Glenn Chapman, Port Charlotte, FL (US)

(72) Inventor: Barry Glenn Chapman, Port Charlotte, FL (US)

(73) Assignee: Barry Glenn Chapman, Port Charlotte, FL (US)

(21) Appl. No.: 13/586,851

(22) Filed: Aug. 15, 2012

Related U.S. Application Data
(60) Provisional application No. 61/575,087, filed on Aug. 15, 2011.

(51) Int. Cl. A01N 25/10; B05D 5/00; A01N 45/00; A01P 1/00; A01N 43/90; A01N 37/18

(52) U.S. Cl. 424/411; 514/200; 514/628; 514/192; 514/152; 427/331

(57) ABSTRACT

The invention discussed is a durable Antimicrobial Strap made using a polymer material, including plastics or vinyl, or a combination thereof, which have been enhanced through the integration of antimicrobial material adapted to kill microbes. The Antimicrobial Strap may be used in applications including but not limited to gait belts, helmet harness, and seat belts in child safety seats where the strap controls the level of cross-contamination by killing unwanted microbes that contact the strap and thereby, prevents the spread of disease and infections.

### CROSS-REFERENCE TO RELATED APPLICATIONS

This is a non-provisional utility patent application that claims the benefit of priority from U.S. Provisional Patent Application Ser. No. 61/575,087, entitled “Antimicrobial Strap” filed Aug. 15, 2011, the disclosure of which is hereby incorporated herein by reference in its entirety.

### FIELD OF INVENTION

The disclosed invention is a strap including antimicrobial properties designed to improve the ability to maintain an antimicrobial free or near antimicrobial free point of contact between hosts in contact with the strap, thereby slowing down or stopping the cycle of spreading pathogens or germs.

### BACKGROUND

In everyday life humans and animals come in contact with inanimate objects. During this contact, microbes are exchanged between the host and the inanimate object. The conventional method for controlling the spread of microbes is to clean the major points of contact to disinfect the inanimate object after such a contact. When used, the conventional method for controlling the spread of microbes may be inhibited by human elements such as failure to see the need for cleaning, failure and inadequacies of policies and procedures, inappropriate methods for cleaning, and inadequate training of staff personnel responsible for cleaning, as well as a poor understanding of proper hygiene by those doing the cleaning. Furthermore, even if the inanimate object is cleaned appropriately, the cleaning does not protect against future transmission of pathogens or germs to the inanimate object in contact with or in close proximity to the inanimate object.

A 2002 study by the Centers for Disease Control and Prevention estimates there were 4.5 hospital infections for every 100 patient admissions and nearly 100,000 deaths from hospital infections. More recent studies have indicated that the rate is increasing due to antibiotic resistance with the expansion in transmission of harmful microbes including MRSA, VRE, C-diff, H1N1, fungi, mold and the like. The high levels of infections are leading to evolving classes of precautions in hospital settings as evidenced by the use of vinyl gloves, introduction of antimicrobial agents into medical devices, emphasis on the impact and importance of thoroughly washing hands and the like.

Currently available methods for cleaning straps are often ineffective or not adhered to.

Antimicrobial coating for use with fibers, filaments, yarns, fabrics and textiles are disclosed in U.S. Pat. No. 7,754,625. Antimicrobial catheters inserted into the bladder via the urethra, normally used once on a person and discarded, is disclosed in U.S. Pat. No. 7,354,605.

What is needed is an Antimicrobial Strap that provides a barrier to the growth of microbes and decreases the amount of cross contamination between hosts coming into contact with the strap.

### SUMMARY OF THE INVENTION

An antimicrobial strap and method of forming is disclosed. The antimicrobial strap decreases the amount of cross-contamination between hosts in contact with the strap by attacking pathogens or germs at the transmission source or point of contact, and thereby continuously preventing against transmission of microbes.

### DRAWINGS

### Figures

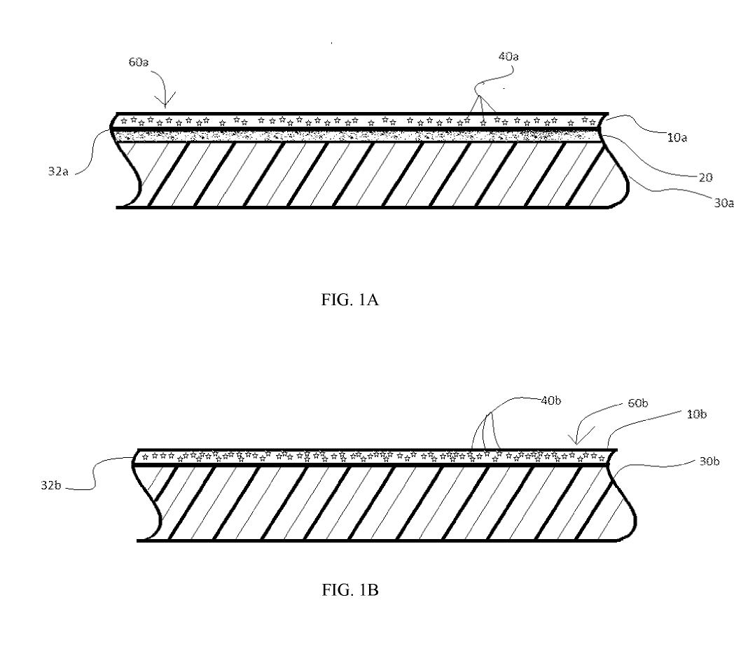

FIG. 1A illustrates a cross-sectional view of an antimicrobial strap including a layer of antimicrobial material coated on an exposed surface of a flexible non-porous substrate formed from a polymer material using an adhesive binder that attaches both to the antimicrobial layer and the polymer material exposed surface of the antimicrobial strap in accordance with an embodiment of the invention.

FIG. 1B illustrates a cross sectional view of an antimicrobial polymer strap manufactured by use of an appropriate binder to form an Interpenetrating Polymer Network that physically binds the antimicrobial agent in an antimicrobial layer to the polymer substrate's surface.

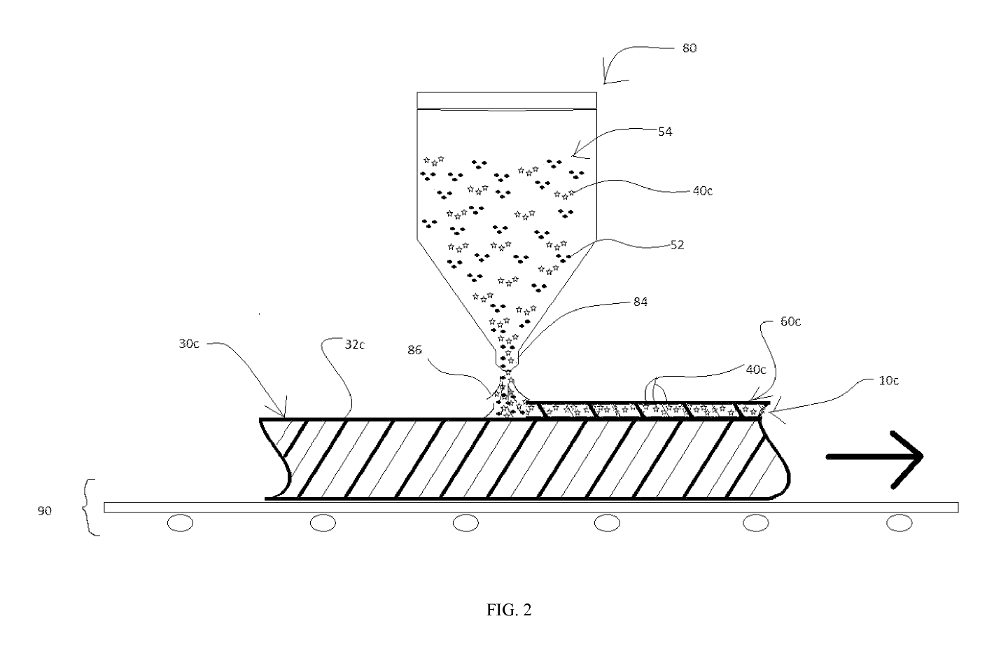

FIG. 2 illustrates a cross-sectional view of an antimicrobial strap including antimicrobial agents that are mixed with polymer particles and coated on to an exposed surface of a polymer substrate material of the antimicrobial strap using a heated plasma spray mechanism to coat a polymer substrate material with an antimicrobial coating properties in accordance with an embodiment of the invention.

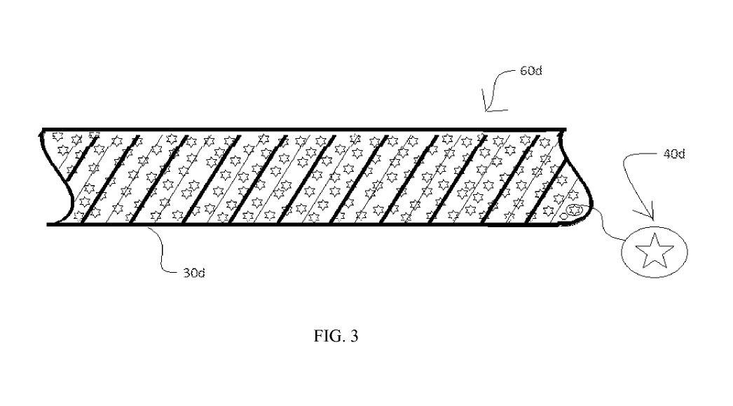

FIG. 3 illustrates a cross-sectional view of an antimicrobial strap including an antimicrobial polymer material that is formed from antimicrobial agents impregnated into the polymer material during the manufacturing process in accordance with an embodiment of the invention including an enlarged view of an antimicrobial agent particle that is uniformly distributed within the polymer substrate material used in constructing the strap in accordance with an embodiment of the invention.

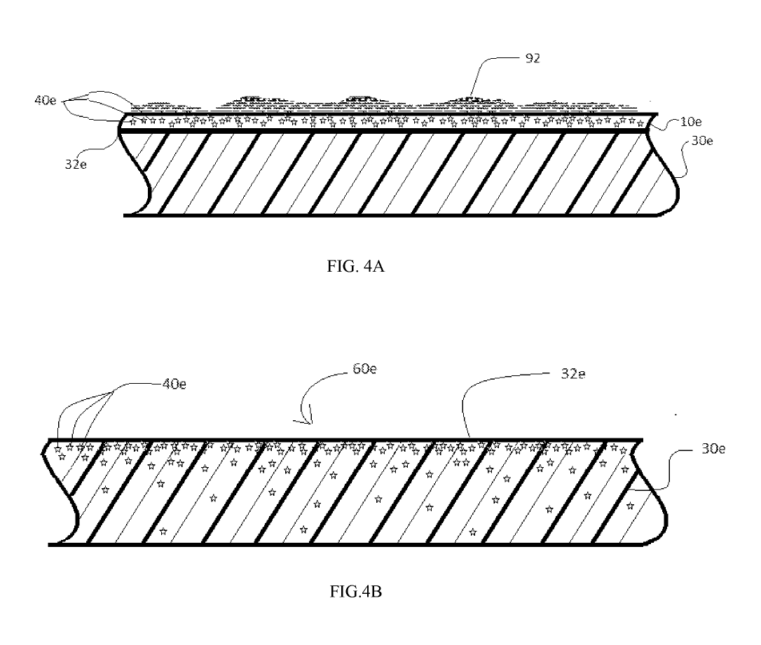

FIG. 4A illustrates a cross-sectional view of an antimicrobial strap wherein an antimicrobial agent is diffused into an exposed polymer substrate material surface of the antimicrobial strap, wherein the diffusion is facilitated by a solvent in accordance with an embodiment of the invention.

FIG. 4B illustrates an antimicrobial polymer after diffusion of the antimicrobial agent into the polymer substrate material in accordance with an embodiment of the invention.

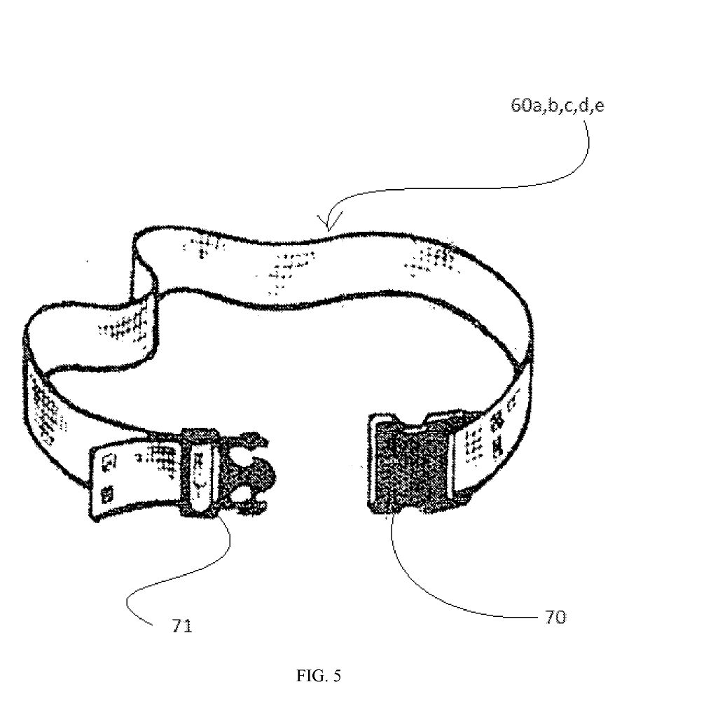

FIG. 5 illustrates a gait belt having antimicrobial properties in accordance with an embodiment of the invention.

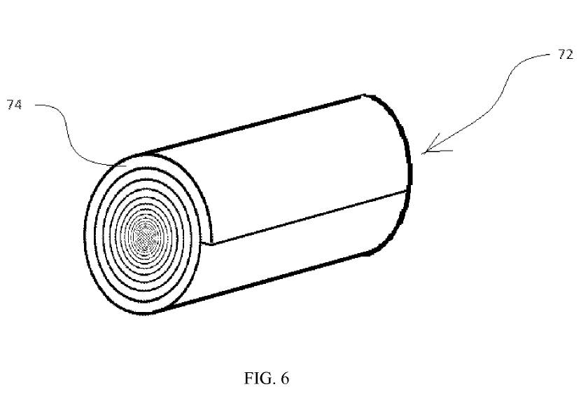

FIG. 6 illustrates a roll of planar non-porous substrate material integrated with an antimicrobial agent in accordance with an embodiment of the invention.

### DRAWINGS

### Reference Numerals

| Antimicrobial Layer | 10a, 10b, 10c, 10e |
|---|---|
| Binder Layer | 20 |
| Polymer Substrate material | 30a, 30b, 30c, 30d, 30e |
| Plurality of Antimicrobial Agents | 40a, 40b, 40c, 40d, 40e |
| Plurality of polymer particles | 52 |
| Powdered mixture | 54 |
| polymer substrate material surface | 32a, 32b, 32c, 32d, 32e |
| Antimicrobial Strap | 60a, 60b, 60c, 60d, 60e |
| Gait Belt Buckle Receptacle | 70 |
| Gait Belt Buckle Prongs | 71 |
| A roll of antimicrobial material integrated | 72 |
| into a non-porous substrate material | |
| Uniform planar sheet | 74 |
| Thermal Gun Assembly | 80 |
| Polymer and Antimicrobial Mixture Reservoir | 82 |
| Heating Mechanism and Nozzle | 84 |
| Atomized Spray | 86 |
| Conveyor Mechanism | 90 |
| Solvent | 92 |

### DETAILED DESCRIPTION OF THE INVENTION

In particular, the invention is directed to antimicrobial polymer straps formed from a combination of antimicrobial and flexible, non-porous substrate materials. The flexible, non-porous substrate materials may be formed from a polymer material that is be made with or treated with an antimicrobial agent.

A polymer material, as defined herein, includes, but is not limited to a polymer, a polymer composition, a polymer composite, or a polymer matrix wherein the polymer material includes plastic or vinyl, or a combination thereof. In an embodiment of the invention, the polymer material is formed from one or more types of polymers, including, but not limited to plastics or vinyl, or a combination of plastic and vinyl, and is manufactured to include a non-porous exposed surface that prevents contamination of the exposed surface after the exposed surface has been exposed to an unwanted microbial contaminate.

In an embodiment of the invention, the polymer material formed from suitable plastics may include any thermoplastic, as long as the thermoplastic processing temperature does not deactivate the active ingredient used. In an embodiment of the invention, a thermoplastic may include thermoplastic elastomers (TPE). TPEs are materials that include elastomeric phases physically incorporated therein by mixing the elastomeric phase into thermoplastically processed polymers or by incorporating the elastomeric phases into the polymers by chemical bonding.

Also, as defined here, an antimicrobial agent has antimicrobial properties to effectively kill or hinder the growth of microbes, which includes but is not limited to viruses, bacteria, mold, fungi, mildew, yeast, and spores, thereby decreasing the spread of pathogens or germs.

The antimicrobial agent integrates antimicrobial properties into the strap, thereby eliminating, or significantly lowering the rate at which infection via microbes spreads to hosts that come into contact with the strap. The concentration of the antimicrobial agent may be modulated to control the bacterial kill efficacy of the antibacterial strap.

The use of an antimicrobial agent in the Antimicrobial Strap hinders or inhibits the ability of microbes to develop and grow and thereby, decreases the amount of cross contamination between hosts coming into contact with inanimate objects having antimicrobial properties of the antimicrobial strap. Therefore, the Antimicrobial Strap fulfills a need to provide a level of barrier to the growth of microbes, to decrease the amount of cross contamination thereof, and to further decrease the spread of pathogens or germs.

The Antimicrobial Strap creates a new field in pathogen or germ control by attacking pathogens or germs at the transmission source or point of contact.

The strap helps eliminate the need for constant and methodical cleaning of the strap as the only procedure by which the spread of infection is controlled. With the use of appropriate antimicrobial agents integrated in the strap's construction, growth and spread of both gram-positive and gram-negative bacteria on the surface of the antimicrobial strap is eliminated or substantially reduced.

The Antimicrobial Strap may be manufactured with a composition that allows cleaning of the strap with standard household and hospital cleaners or disinfectants without hampering the strap's antimicrobial properties or abilities to effectively hinder or inhibit growth of microbes.

The Antimicrobial Strap is manufactured with a non-porous polymer material on all external surfaces, thereby preventing contamination of the surfaces before and after the Antimicrobial Strap has been cleaned. Additionally, all the surfaces forming the Antimicrobial Strap including surfaces bounded by the strap's length L and width W, surfaces bounded by the strap's length L and thickness T, and the surfaces bounded by the strap's width W and thickness T are nonporous and therefore, free from contamination both before and after the surfaces have been cleaned.

In an embodiment of the invention, the antimicrobial agent used is an oxidizing agent that oxidizes microbes by attracting, trapping and then oxidizing negatively charged virus, bacteria, mold, fungi and spores and thereby effectively killing or hindering the growth of such bacteria, mold, fungi and spores. In an embodiment of the invention, the antimicrobial agent is an oxidizing agent such as, but not limited to the oxidizing agent sold under the trademark OxiTitan™, manufactured by EcoActive Surfaces, Inc., Pompano Beach, Fla. 33061-0338. The OxiTitan™ oxidizing agent is a photo-catalyst mixture including zinc nano-particles in a matrix of non-crystalline titanium dioxide, wherein the positive charge of the mixture attracts, traps and then oxidizes the negatively charged virus, bacteria, mold, fungi and spores. Any oxidizing agent may be used that is suitable to oxidize microbes.

In an embodiment of the invention, the manufacturing of the antimicrobial polymer or polymer composition, including plastics or vinyl or a combination thereof, includes the antimicrobial agent bonded to the polymer or polymer composition. In an embodiment of the invention, the antimicrobial agent is a quaternary ammonium compound that chemically bonds to the polymeric substrate but does not leach or off-gas and does not lose effectiveness over time. In an embodiment of the invention, the antimicrobial agent may be, but is not limited to, a quarternary ammonium compound sold under the trademark Biosafe® HM 4100, manufactured by BIOSAFE, Inc., Suite 400, 100 Technology Drive, Pittsburg, Pa. 15219. Biosafe® HM 4100 is a polymeric powder that is environmentally sustainable silane-based cationic quarternary ammonium salt, that is easily compounded into plastics, and that is then mixed into coatings. The active ingredient in the HM 4100 technology forms a colorless, odorless, positively charged polymer that molecularly bonds to product substrates,—making the positively charged polymer material combined with the product substrate antibacterial and acts by puncturing and rupturing negatively charged bacteria cells.

Another method of integrating antimicrobial agents into the flexible, non-porous substrate material forming the antimicrobial strap includes use of ion exchange methods, such as is disclosed in U.S. Pat. No. 7,754,625, which is herein incorporated by reference, wherein non-antimicrobial ions are wholly or partially replaced by antimicrobial copper and silver ions.

In several embodiments of the invention, any one or more of the following active ingredients having antimicrobial properties may be suitable to incorporate into the antimicrobial strap: ansamycin derivatives (rifamycin, rifapentin), and preferably any additional antimicrobial substances that have also been used for clinical purposes for what are known as difficult-to-treat infections. In another embodiment of the invention, any one or more of an antimicrobially active group disclosed in U.S. Pat. No. 7,705,073, the disclosure of which is herein incorporated by reference in its entirety, may be suitable to incorporate into the antimicrobial strap including: lipophilic members of the amino glycosides group, of the cephalosporin group and beta-lactams based thereon, of chloramphenicol, lincosamides, macrolides, penicillin, quinolones, sulphonamides, tetracycline, except the combination tetracycline-minocyclin. Lipophilic antibiotics are preferably: benzathin, phenoxymethylpenicillin, chloramphenicol, chlortetracyclin, ciprofloxacin betaine, ciprofloxacin, clarithromycin, clindamycin palmitate hydrochloride, trimethoprim, erythromycin 2-acetate, and the corresponding stearate; erythromycin estolate, erythromycin ethyl succinate, erythromycin glutamate, erythromycin lactopropionate, erythromycin stearate, fusidinic acid, preferably free fusidinic acid, gramicidin, mupirocin, lipophilic members of the imidazole series, such as econazole, itraconazole, clotrimazole and others, pristinamycin, rifabutin, rifapentin, rifampicin, silver sulfadiazine.

Generally, the flexible, non-porous substrate material is enhanced with antimicrobial agents. In several embodiments of the invention, the antimicrobial agents are either bonded with or directly integrated into the flexible, non-porous substrate material forming the antimicrobial strap to enhance the kill efficacy of microbes.

In an embodiment of the invention, the flexible, non-porous substrate material is formed by a polymer substrate material, which in an embodiment of the invention, may be selected from a family of plastics or vinyl, or a combination thereof. In another embodiment of the invention, the polymer substrate material is formed as an Interpenetrating Polymer Network (IPN) that includes two or more polymer networks, which are partially interlaced, though not covalently bonded to each other. Although not held together by chemical bonds, the polymer networks are entanglements and concatenations of polymer networks, which prevent separation of the IPN and add tensile strength to the IPN.

The antimicrobial polymer straps may be prepared in a number of different ways depending upon the specific polymer material substrate and the stage at which the antimicrobial agent is introduced to the polymer material.

In an embodiment of the invention, the Antimicrobial Strap includes: a polymer material including an exposed surface, and an antimicrobial agent, wherein the antimicrobial agent is integrated within the exposed surface of the antimicrobial strap.

Referring now to the figures, FIGS. 1A and 1B illustrate a cross-sectional view of an embodiment of the invention where an antimicrobial agent is bonded to an underlying exposed surface of a non-porous substrate material such as a polymer material used to form an antimicrobial strap.

In an embodiment of the invention shown in FIGS. 1A and 1B, the antimicrobial polymer strap includes the polymer substrate material 30a (FIG. 1A), 30b (FIG. 1B) laminated with one or more layers of antimicrobial agent to form a laminated coating, wherein the laminated coating is an integral part of the polymer or polymer composition manufacturing process. The coating does not significantly degrade over time and provides needed efficacy for preventing growth of microbes over exposed surfaces of the antimicrobial strap throughout the average lifespan of the apparatus with or within which the invention is used.

FIG. 1A illustrates a cross-sectional view of an antimicrobial strap 60a including an antimicrobial layer 10a formed from a plurality of antimicrobial agents 40a that is coated on the exposed polymer material substrate surface 32a with the addition of a layer of binder 20 that adheres to the both antimicrobial layer 10a and the polymer material substrate surface 32a.

The antimicrobial agent may be applied to the polymer substrate material by use of a laminate coating using an appropriate binder that physically binds the antimicrobial agents 40a to the surface 32a of the polymer substrate material.

The antimicrobial material is coated on exposed surfaces of the antimicrobial strap using an adhesive binder layer 20 that attaches both to the antimicrobial layer 10a and the polymer substrate material surface 32a of the antimicrobial strap 60a in accordance with an embodiment of the invention. In the embodiment of the invention shown in FIG. 1A, the thickness of the laminate antimicrobial and binder layers are much less than the thickness of the flexible non-porous substrate layer 30a.

In another embodiment of the invention, the antimicrobial polymer strap is formed as an Interpenetrating Polymer Network (IPN) that includes two or more polymer networks, which are partially interlaced though not covalently bonded to each other. Although not held together by chemical bonds, the polymer networks are entanglements and concatenations of polymer networks, which prevent separation of the IPN and add tensile strength to the IPN.

In another embodiment of the invention shown in FIG. 1B, the antimicrobial polymer strap 60b may be manufactured by use of an appropriate binder to form an IPN that physically binds the antimicrobial agent 40b in an antimicrobial layer 10b to the polymer substrate's surface 32b.

In an embodiment of the invention, an antimicrobial coating, such as, but not limited to the variety of antimicrobial coatings sold under the trademark of Agion®, manufactured by the Sciessent company, headquartered in 60 Audubon Road, Wakefield, Mass. 01880, that use silver ions as primary active antimicrobial ingredient may be used on a polymer substrate material surface to inhibit the growth of microbes.

In another embodiment of the invention, an antimicrobial strap including antimicrobial agents that are mixed with polymer particles and coated on to an exposed polymer substrate material of the antimicrobial strap in accordance with an embodiment of the invention.

In another embodiment of the invention, the antimicrobial agent may be applied to the polymer material strap by use of a polymer- or resin-based coating applied to the exposed surfaces of the polymer substrate material.

In another embodiment of the invention, the antimicrobial layer includes a polymer particle material that adheres to the strap surface of the polymer substrate material being coated and an active antimicrobial agent which is chemically or ionically bonded to the particle polymer material, wherein the polymer particle material has a glass transition temperature that is lower than the melting point of the antimicrobial agent, thus enabling the polymer particle material to melt and bond to the antimicrobial agent before the antimicrobial agent begins to melt.

In an embodiment of the invention shown in FIG. 2, the polymer particle material used is in a powder form with an average particle size of about 20 microns to about 80 microns. In another embodiment of the invention, nano-particle size polymers 52 may be used with average particle size of 25 nanometers to about 40 nanometers. The antimicrobial agents 40c added to the polymer particle material are in a powder form, wherein the average particle size of the antimicrobial agent 40c is comparable to the size of the polymer particles 52 to provide a uniform distribution of polymerparticles and antimicrobial agents throughout the antimicrobial layer 10c coated onto the polymer substrate material 30c.

In an embodiment of the invention, the polymer particle material used may be a polymide including various types of nylon such as nylon 11 or nylon 12, or a powder coating resin that exhibits increased adhesion to the polymer substrate material's exposed surfaces of the antimicrobial strap. In an embodiment of the invention, the blended mixture of the polymer particle material and the antimicrobial agent, which includes 0.001% to 20% by weight of the antimicrobial agent, is heated above the glass temperature of the polymer particle material, but below the melting temperature of the antimicrobial agent. In another embodiment of the invention, the heated blended polymer particle material and the antimicrobial agent-polymer mixture is sprayed on the polymer substrate material to form the antimicrobial layer of the antimicrobial strap.

In an embodiment of the invention as shown in FIG. 2 a high velocity impact fusion plasma spray gun is used, such as one disclosed in U.S. Pat. No. 5,285,967, which is incorporated herein by reference, to spray-coat the exposed surfaces of the polymer substrate material 30c with the molten mixture of melted polymer powder and antimicrobial agent.

FIG. 2 illustrates an embodiment of the invention wherein a heated plasma spray mechanism is used to coat a polymer substrate material 30c with an antimicrobial layer coating 40c. In an embodiment of the invention, a polymer substrate material 30c is mounted on a conveyor mechanism 90. The plasma spray gun 80 includes a reservoir 82 that contains a powdered mixture 54 of matrix polymer 52 and antimicrobial agents 40c for use in generating the antimicrobial layer 10c. The spray gun 84 includes a heating mechanism to melt the mixture 54. The molten mixture is atomized into an atomized spray 86 using a high pressure spray gas included within the spray gun 80. The speed of conveyor mechanism, the pressure of the spray gas, consistency of the powder, and the melting temperature are controlled to obtain a uniform antimicrobial coating 10c.

The antimicrobial layer 10c is coated on the polymer material surface 30c and bonds to the polymer material surface. Antimicrobial coating 10c includes a matrix polymer- or resin-based coating that adheres to the underlying polymer material surface 30c wherein active antimicrobial agents 40c have been added. The antimicrobial coating is applied to the exposed polymer material surface 30c as shown in the FIG. 2.

In another embodiment of the invention shown in FIG. 3, an antimicrobial strap 60d includes a polymer substrate material 30d that is formed from antimicrobial agents 40d impregnated into the polymer substrate material 30d during the manufacturing process in accordance with an embodiment of the invention.

FIG. 3 shows the antimicrobial agent 40d incorporated directly into the composition of the polymer substrate material when the polymer substrate material is manufactured. The incorporation of the antimicrobial agent into the polymer substrate material may be through a diffusion process.

In an embodiment of the invention illustrated in FIG. 3, the polymer substrate material 30d used to form the antimicrobial strap 60d is manufactured with material that includes antimicrobial agents 40d. In an embodiment of the invention, the antimicrobial agents included in the composition of the polymer material layer are microscopic in nature.

FIG. 3 further shows an enlarged in view of an antimicrobial agent particle 40d that is uniformly distributed within the material 30d used in constructing the strap in accordance with an embodiment of the invention.

Manufacturing of antimicrobial plastics compositions may be achieved via the use of thermoplastic processing wherein any of the variety of active ingredients with antimicrobial properties are used.

As shown in FIGS. 4A-4B the antimicrobial polymer may be manufactured by applying an antimicrobial layer 10e of the antimicrobial agent 40e to the polymer's exposed surfaces 32e by use of an appropriate solution or solvent 92 that effects an infusion or impregnation of the antimicrobial agent 40e into the surface 32e of the polymer substrate material 30e or polymer composition.

FIG. 4 illustrates the cross-sectional view of another embodiment of the invention of an antimicrobial strap wherein the antimicrobial agents 40e are diffused into an exposed polymer substrate material surface 32e of the antimicrobial strap 60e, wherein diffusion of the antimicrobial layer 10e is facilitated by the use of an appropriate chemical solvent 92 including water that fosters the flow of antimicrobial particles into the underlying polymer substrate material's exposed surface 32e. In an embodiment of the invention, the chemical solvent 92 fosters the formation of a chemical or ionic bond of the antimicrobial agent 40e with the underlying polymer material exposed surface 32e.

The antimicrobial polymer composition forming the antimicrobial strap 60a, 60b, 60c, 60d, 60e may be reinforced by reinforcement materials such as polyester or equivalent webbing adhered or attached to the strap in any manner suitable that does not inhibit the antimicrobial properties of the strap and that increases the strap's strength.

The Antimicrobial Strap 60a, 60b, 60c, 60d, 60e described has many uses and maybe adapted to serve as shopping cart straps, helmet straps, stretcher straps, gait belts, purse straps, seat belts, crossing guard straps, belts for CT and MRI scanning, as functional barriers at airports, banks, and anywhere where such barriers against microbes are needed. The strap provides a nonporous antimicrobial material used to form straps, strapping, belts, belting and the like. In an embodiment of the invention as shown in FIG. 5, the Antimicrobial Strap is used in the formation of belts wherein the antimicrobial belts may or may not have accessory attachments for adjusting the belt's length.

Furthermore, additional components or accessories may be added to the antimicrobial strap, such as the detachable buckles when disclosed invention is used as shopping cart straps, helmet straps, stretcher straps, gait belts, purse straps, seat belts, crossing guard straps, belts for CT and MRI scanning, as functional barriers at airports, banks, and anywhere where such microbial barriers are needed. FIG. 5 illustrates a perspective view of gait belt having antimicrobial properties in accordance with an embodiment of the invention.

FIG. 5 illustrates the use of the Antimicrobial Strap having antimicrobial properties disclosed in construction of a gait belt of the type used in the medical profession for patient care. A first end of antimicrobial strap 60 is attached to the buckle receptacle 70 and an opposing second end of the antimicrobial strap 60 is attached to a buckle prong 71 wherein the buckle prong 71 and the buckle receptacle 70 are complementary components of a buckle assembly.

In an embodiment of the invention shown in FIG. 6, the strap may be formed from a uniform planar sheet 74 of antimicrobial non-porous polymer material manufactured as a roll 72 of antimicrobial polymer formed by any of the methods disclosed herein and cut to a desired dimension. In an embodiment of the invention, the manufactured roll of antimicrobial polymer may include, but is not limited to the following dimensions of: thickness of 0.05 to 0.25 inches, width of 0.25 to 128 inches, and length of 72 yards.

The roll 72 of antimicrobial polymer material (sheet 74) may be prepared using any of the plurality of methods disclosed herein suitable to incorporate the antimicrobial properties required to inhibit microbial growth. The methods used in manufacturing the antimicrobial roll are determined by the specific substrate properties of the polymer material being used to form the antimicrobial strap, the type of antimicrobial agent used to form the strap, and the particular manufacturing stage of the antimicrobial polymer wherein the antimicrobial agent is introduced. Further, the belt may be formed by cutting out the Antimicrobial Strap from a roll of antimicrobial stock.

The antimicrobial and flexible non-porous substrate materials forming the strap 60a, 60b, 60c, 60d, 60e (as shown in FIGS. 1A, 1B, 3, 4B) may have width and length dimensions that are determined by the intended use of the strap. In an embodiment of the invention, a thickness of the strap 60 is much smaller than the width.

While several aspects have been presented in the foregoing detailed description, it should be understood that a vast number of variations exist and these aspects are merely an example, and it is not intended to limit the scope, applicability or configuration of the invention in any way. Rather, the foregoing detailed description provides those of ordinary skill in the art with a convenient guide for implementing a desired aspect of the invention and various changes can be made in the function and arrangements of the embodiments of the invention without departing from the spirit and scope of the appended claims.

What is claimed is:

1. An Antimicrobial Strap comprising:
a flexible non-porous substrate material including an exposed surface; and
an antimicrobial agent, wherein the antimicrobial agent is integrated within the exposed surface of the non-porous substrate.

2. The Antimicrobial Strap of claim 1, wherein the non-porous substrate material comprises:
a polymer material.

3. The Antimicrobial Strap of claim 2, wherein the polymer material comprises:
a plastic material.

4. The Antimicrobial Strap of claim 3, wherein the plastic material comprises:
a thermoplastic.

5. The Antimicrobial Strap of claim 3, wherein the polymer material comprises:
a vinyl material.

6. The Antimicrobial Strap of claim 3, wherein the polymer material comprises:
a combination of plastic and vinyl materials.

7. The Antimicrobial strap of claim 3, comprising:
an antimicrobial polymer material formed from the antimicrobial agent that is infused or impregnated into the polymer material's exposed surface by use of a solvent.

8. The Antimicrobial Strap of claim 7, wherein the solvent comprises:
a chemical solvent that fosters the formation of a chemical or an ionic bond of the microbial agent with the polymer material's exposed surface.

9. The Antimicrobial strap of claim 7, comprising:
an antimicrobial polymer material formed from the antimicrobial agent infused or impregnated into the polymer material during a manufacturing process.

10. The Antimicrobial Strap of claim 9, wherein a distribution of the antimicrobial agent infused or impregnated into the polymer material during manufacturing process is uniform.

11. The Antimicrobial Strap of claim 10, wherein the manufacturing process comprises:
a thermoplastic process.

12. The antimicrobial strap of claim 2, further comprising:
a rolled sheet of polymer substrate material coated with the antimicrobial agent.

13. The Antimicrobial Strap of claim 1, wherein the antimicrobial agent comprises:
a material selected from a group consisting of Lipophilic antibiotics; and lipophilic members of: the amino glycosides group, the cephalosporin group and beta-lactams based thereon, chloramphenicol, lincosamides, macrolides, penicillin, quinolones, sulphonamides, tetracycline, except the combination tetracycline-minocyclin.

14. The Antimicrobial Strap of claim 1, further comprising:
a binder that binds the antimicrobial agent to the exposed surface of the flexible non-porous substrate material.

15. An Antimicrobial Strap of claim 1, further comprising
a reinforcement material that reinforces the strength of the antimicrobial strap, and does not inhibit the antimicrobial properties of the strap.

16. The antimicrobial strap of claim 15, wherein the reinforcement material comprises:
a polyester material.

17. The antimicrobial strap of claim 1, further comprising:
a belt; and
an attachment mechanism to attach the belt to another object.

18. The antimicrobial strap of claim 1, further comprising:
a rolled sheet of material having the flexible non-porous substrate material and the antimicrobial agent integrally formed therewith.

19. A method of forming an Antimicrobial Strap comprising:
integrating an antimicrobial agent into an exposed surface of a non-porous polymer material.

20. The method of claim 19, further comprising:
laminating the polymer material with laminates of the antimicrobial agent.
